(19) United States
(12) Patent Application Publication
(10) Pub. No.: US 2013/0308013 A1
(43) Pub. Date: Nov. 21, 2013

(54) UNTOUCHED 3D MEASUREMENT WITH RANGE IMAGING

(71) Applicants: Jingquan LI, Auburn, NY (US); Ynjiun Paul WANG, Cupertino, CA (US); Stephen Patrick DELOGE, Palmyra, NY (US)

(72) Inventors: Jingquan LI, Auburn, NY (US); Ynjiun Paul WANG, Cupertino, CA (US); Stephen Patrick DELOGE, Palmyra, NY (US)

(73) Assignee: Honeywell International Inc. d/b/a Honeywell Scanning and Mobility, Fort Mill, SC (US)

(21) Appl. No.: 13/475,336

(22) Filed: May 18, 2012

(51) Int. Cl. H04N 5/76

(52) U.S. Cl. 348/231.3; 348/E05.024

(57) ABSTRACT

A user terminal contains an input/output mechanism, an image capture device used to capture an image of a scene, a range imaging image capture device used to create a depth map of the scene, a processor that combine the image and the depth map into a model of the scene, a memory that stores the depth map and the image, and a display that displays the model. Utilizing this system, a user is able to view, measure, and calculate 3D data representing real world data, including but not limited to position, distance, location, and orientation of objects viewed in the display. The retrieves this information by making inputs into the terminal, including, in an embodiment of the invention, touch inputs selecting images on a touch screen.

### FIELD OF INVENTION

The present invention provides an apparatus and method to measure objects, spaces, and positions and represent this three dimensional information in two dimensions.

### BACKGROUND OF INVENTION

Imaging functionality has become a standard feature in mobile devices, such as camera phones, personal data terminals, smart phones, and tablet computers. Many of these devices also accept input from users via a touch screen interface.

A limitation of these mobile imaging devices, and many imaging devices in general, is that although they can be used to capture images, the resultant image, a two-dimensional image as displayed on a given mobile device's user interface, does not reflect the three dimensional nature of the objects being captured. For example, there is no perspective offered to the user through the interface insofar of the actual distances of one object from another object. The device, after image capture, cannot provide the user with information regarding the distances between objects displayed without more data. The single image captured in two dimensions loses the three dimensional information of the physical world.

A new technique called Time of Flight (TOF) describes a variety of methods used to measure the time that it takes for an object, particle or acoustic, electromagnetic or other wave to travel a distance through a medium. This measurement can be used for a time standard (such as an atomic fountain), as a way to measure velocity or path length through a given medium, or as a way to learn about the particle or medium (such as composition or flow rate). The traveling object may be detected directly (e.g., ion detector in mass spectrometry) or indirectly (e.g., light scattered from an object in laser doppler velocimetry).

A TOF camera, also called a depth camera, ranging camera, flash lidar, and/or RGB-D camera, is a range imaging camera system that resolves distance based on the known speed of light, measuring the time-of-flight of a light signal between the camera and the subject for each point of the image. The TOF camera is a class of scannerless LIDAR (Light Detection And Ranging), in which the entire scene is captured with each laser or light pulse, as opposed to point-by-point with a laser beam such as in scanning LIDAR systems. In short, TOF cameras measure the depth of a scene by quantifying the changes that an emitted light signal encounters when it bounces back from objects in a scene.

TOF is part of a group of techniques used for “range imaging.” Range imaging is the same for a collection of techniques which are used to produce a two dimensional (2D) image showing the distance to points in a scene from a specific point. Range imaging is normally associated with sensor devices and includes, but is not limited to, TOF, stereo triangulation, sheet of light triangulation, structured light, Interferometry, and coded aperture.

As the performance of range imaging techniques improve and their prices decrease, the integration of range imaging into off-the-shelf mobile devices is more plausible. Through this integration, the two dimensional image displayed to a user on an interface could be enriched with three dimensional information.

A need therefore exists for a way to utilize a handheld mobile device to convey three dimensional information to a user regarding images captured by the device.

### SUMMARY OF INVENTION

An object of the present invention is to provide an apparatus and method to measure objects, spaces, and positions and represent this three dimensional information in two dimensions. Three dimensional information includes but in not limited to the distances of objects from each other, the angular information of the camera to the object plains in the camera view, the area and shapes of the surfaces, and the volumes of objects.

An embodiment of the present invention comprises: (1) a device with a standard digital camera; (2) a touch screen user interface capable of allowing a user to select a pixel position by making an input; (3) a range imaging camera; (4) a processor capable of executing computer program code. The computer program code to be executed on the processor may be located on a storage resource internal and/or external to the device.

In further embodiments of the present invention, a variety of range imaging cameras, various devices that can provide depth maps together with regular images, are utilized, including but not limited to a structured light camera and/or a TOF camera. The system and method of the present invention can be practiced provided a device can acquire depth maps as well as regular images.

By integrating a range imaging camera, such as a structured light camera, into a handheld device with a traditional camera, the resulting device provides three dimensional image information including but not limited to, information regarding the distances between objects captured and displayed on screen, angular information describing the orientation of the camera relative to the object plains in the camera view, and/or the area and shapes of the surfaces, and the volumes of the objects.

In an embodiment of the present invention, a user may interact with the touch screen of a mobile device by utilizing a stylus, as an “inquiry tool.” This tool allows the user to indicate portions of a two dimensional image displayed on the user interface of the mobile device and request three dimensional object information including but not limited to the real world position and/or orientation of the object.

In an embodiment of the present invention, the traditional camera integrated into a device captures an image. This image is sharpened and then, the integrated range imaging camera is utilized to measure distances between the device and various objects in the field of view, creating a depth map. These measurements are utilized to make three dimensional computations that represent not only the relationship between the device and objects in the space, but also relationships between the objects themselves. The three dimensional computations are then displayed to the user through the integrated graphical user interface, optionally using three dimensional graphics.

For example, in an embodiment of the present invention, when a user utilizes the inquiry tool to select a point on the touch screen, the distance (from the camera) to the object will be reported. When the user seconds a second point, the distance between that point and the first point selected, in the real world, is reported to the user. Should the user select three points, the area of the triangle comprised on these points and the angles (of the planes) representing the position of the points relative to each other will be reported. Further embodiments of the present invention receive user input from keyboards, and/or mouses.

An embodiment of the present invention can build a 3D model based on the data, and the user can utilize the touch screen displaying the image to rotate the image, moving the image around to see different parts of the view, and zoom in or out of various portions of the image. An embodiment of the present invention additionally enables the user to monitor selected objects for changes and to track selected objects.

Additional embodiments of the present invention accept different types of user input including, but not limited to, finger touch and/or multiple touch inputs, combined touch events and the input of special graphics.

An embodiment of the present invention adds suggested outlines and vertices to guide the user and accept the candidate position nearest to the touched coordinates.

An embodiment of the present invention allows the user to verify the item selected after the selecting is made by highlighting the selection and awaiting confirmation.

An embodiment of the present invention reports the length of curve, area of region, volume of object, reflecting the real world position of objects displayed to the user in the user interface.

Various embodiments of the present invention enable certain functionalities based upon the type of object the user selects through the GUI. Selections that are tied to functionality include but are not limited to: point(s), line(s), plane(s), shape(s), object(s), and/or color(s).

Various embodiments of the present invention allow the user to view the captured image and depth map in a variety of modes. Modes includes but are not limited to 2D view, depth map view, 3D rendering/with texture and/or augmented view. An embodiment of the present invention enables the user to switch between view modes.

### BRIEF DESCRIPTION OF DRAWINGS

FIG. 1 depicts an embodiment the present invention.

FIG. 2 depicts an aspect of an embodiment the present invention.

FIG. 3 depicts a workflow of an embodiment of the present invention.

FIG. 4 depicts an aspect of an embodiment the present invention.

FIG. 5 depicts an aspect of an embodiment the present invention.

FIG. 6 depicts an aspect of an embodiment the present invention.

FIG. 7 depicts an aspect of an embodiment the present invention.

FIG. 8 depicts an aspect of an embodiment the present invention.

FIG. 9 depicts an aspect of an embodiment the present invention.

FIG. 10 depicts a workflow of an embodiment of the present invention.

### DETAILED DESCRIPTION OF THE INVENTION

The present invention provides an apparatus and method to measure objects, spaces, and positions and represent this three dimensional information in two dimensions.

An embodiment of the present invention uses various range imaging techniques, including different categories and realizations, to provide mobile users with the ability and tools to perform 3D measurement and computations interactively, using a graphical user interface (GUI) displayed on a touch screen.

To interact with image displayed in the GUI on the touch screen, the user utilizes a touch pen, also called a stylus, an “inquiry tool” to indicate the user's choice of positions from the screen. In this manner, the embodiment enables the user to measure objects, spaces, and positions without personally investigating the objects in the images.

A range imaging camera is a device that can provide a depth map image together with the regular image. Range imaging cameras include but are not limited to structured light cameras and TOF cameras. The combination of image data and depth information is utilized to enhance captured two dimensional images with real world, three dimensional, data.

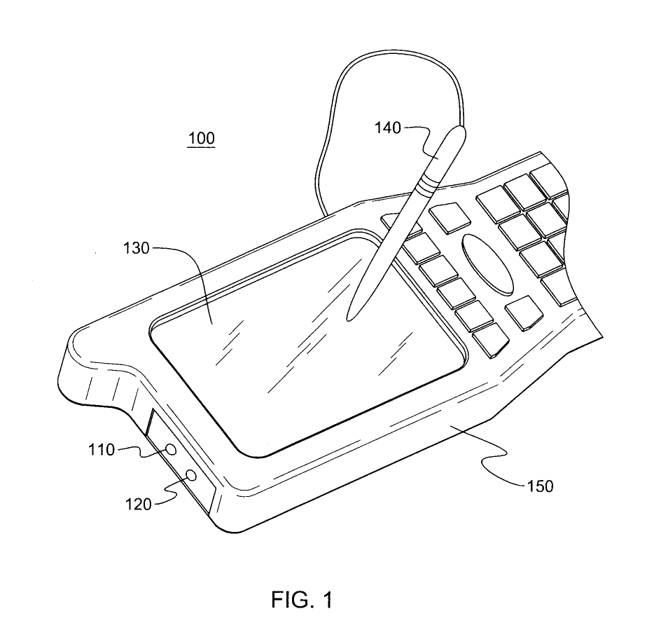

FIG. 1 is an embodiment of the apparatus 100 of the present invention. Referring to FIG. 1, this apparatus 100 is a handheld mobile device. Integrated into the device are a standard digital camera 110 and a range imaging camera 120, such as a structured light camera. The user interface of this embodiment of the apparatus is a touch screen 130.

The touch screen 130 makes it easy for a user to select a portion of a displayed image that he or she wants more information about. The touch screen 130 also allows the user to isolate parts of the image displayed to zoom in or out, re-center, manipulate, etc. In the 3D model based on the data, the user can utilize the touch screen displaying the image to rotate the image, move the image around to see different parts of the view, and zoom in or out of various portions of the image.

Further embodiments of the present invention may employ an input device other than a touch screen 130. These embodiments of the present invention include a keyboard and/or keypad to input keystrokes and/or a mouse. In an embodiment, left/right mouse button actions are combined with key strokes to represent more variation of actions. Actions on various embodiments include, but are not limited to, right clicking on a mouse to pop up options, using a designated shortcut key to change the “mode of view” (e.g., RGB image, depth image, and/or augmented image), and/or offering a variety of shortcut keys for various actions, including the option to assign a shortcut key to a commonly used function. Although selection of pixels on the display may be a more involved process, it is still possible and effective.

FIG. 1 includes a touch screen 130 because many mobile devices are moving towards employing touch screens and the system and method described can be integrated into existing handheld devices.

Returning to FIG. 1, a user makes selections and inputs on the touch screen 130 using a touch pen 140. The apparatus 100 is equipped with an internal processor 150 capable of executing computer code.

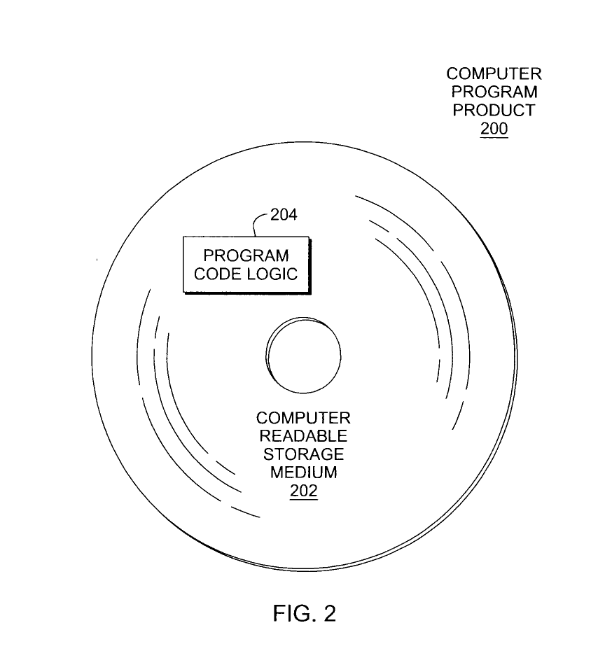

Computer-readable code or instructions need not reside on processor 150. Referring to FIG. 2, in one example, a computer program product 200 includes, for instance, one or more non-transitory computer readable storage media 202 to store computer readable program code means or logic 204 thereon to provide and facilitate one or more aspects of the present invention.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language, such as Java, Smalltalk, C++ or the like, and conventional procedural programming languages, such as the “C” programming language, assembler or similar programming languages. The program code may execute entirely on processor 150 or on a remote computer systems resource accessible to processor 150 via a communications network.

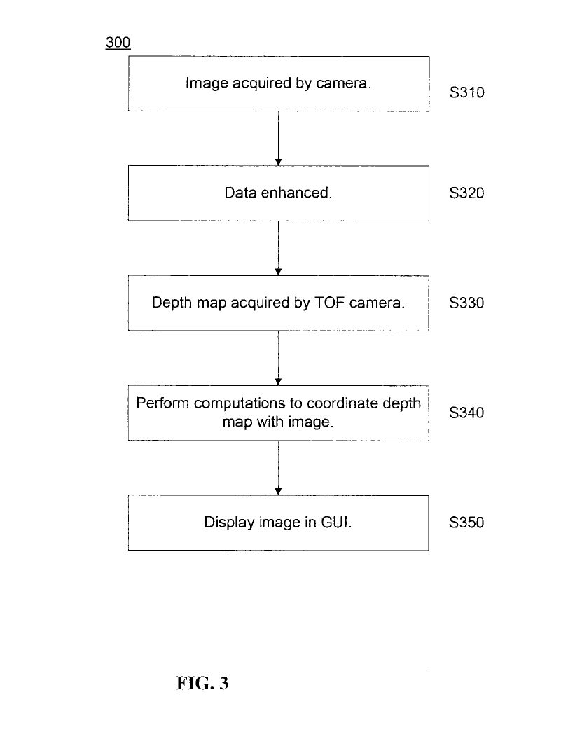

FIG. 3 describes the workflow 300 of an embodiment of the present invention in rendering a three dimensional image, and/or a two dimensional image that offers three dimensional data on a user interface, such as the touch screen 130 display of the apparatus 100 in FIG. 1. Thus, the scene that is captured by an image capture device and by a range imaging device is displayed in the GUI.

First, the image data is acquired by a digital camera (S310); the image data is a digital image. Next, this data is enhanced in order to comprehend the objects captured in the field of view of the camera, which will be analyzed further using a depth acquisition device, such as a range imaging camera (S320). Once the image data is sharpened, the range imaging camera is initiated and makes distance measurements with the field of view (S330). The individual distance measurements are compiled to derive the positioning of the objects in the field of view relative to the device and also, relative to each other (S340). Once the computations have occurred, the resultant image is displayed in the graphical user interface (S350). The displayed image includes, but is not limited to, a two dimensional image with real world positioning noted in text, and/or three dimensional graphic representations of the image.

In an embodiment of the present invention, the device utilizes the digital and range imaging cameras to acquire a depth image and a regular image, either gray or RGB. The cameras may need to take multiple frames in order to get a mean image as the input. If the images have not been aligned, they are then aligned. The regular image is then denoised and enhanced and the depth map is also denoised and enhanced before a representative image is rendered in the GUI.

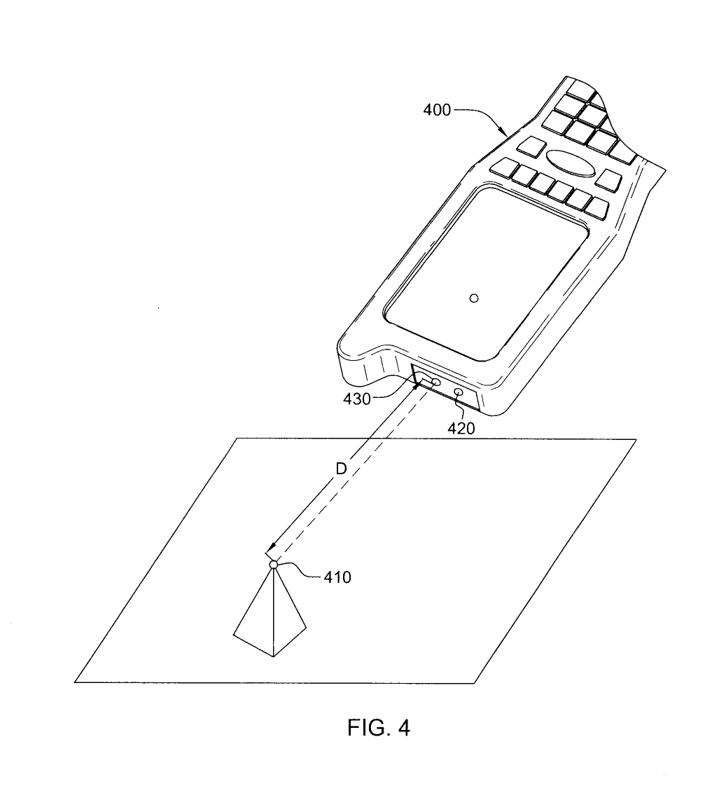

FIG. 4 depicts a handheld device with the ability to acquire a combination of image data and depth information, such as the apparatus 100 of FIG. 1, taking a basic distance measurement (S320), as described in the workflow of FIG. 3. Referring to FIG. 4, the range imaging camera 430 integrated into the mobile device 400 utilizes a laser or light pulse to measure the depth of a scene by quantifying the changes that an emitted light signal encounters when it bounces back from objects in a scene. The range imaging camera 430 emits light, which bounces back from the object 410 in the field of view of the range imaging camera 430 and the traditional camera 420.

In an embodiment of the present invention, after the image is displayed in the graphical user interface, a user may select portions of the image and receive data regarding the relative and/or actual positioning of the items selected relative to each other. The user can also indicate objects captured in the view and receive information about those objects, including size parameters (height, width, depth), and/or the volume of the objects selected.

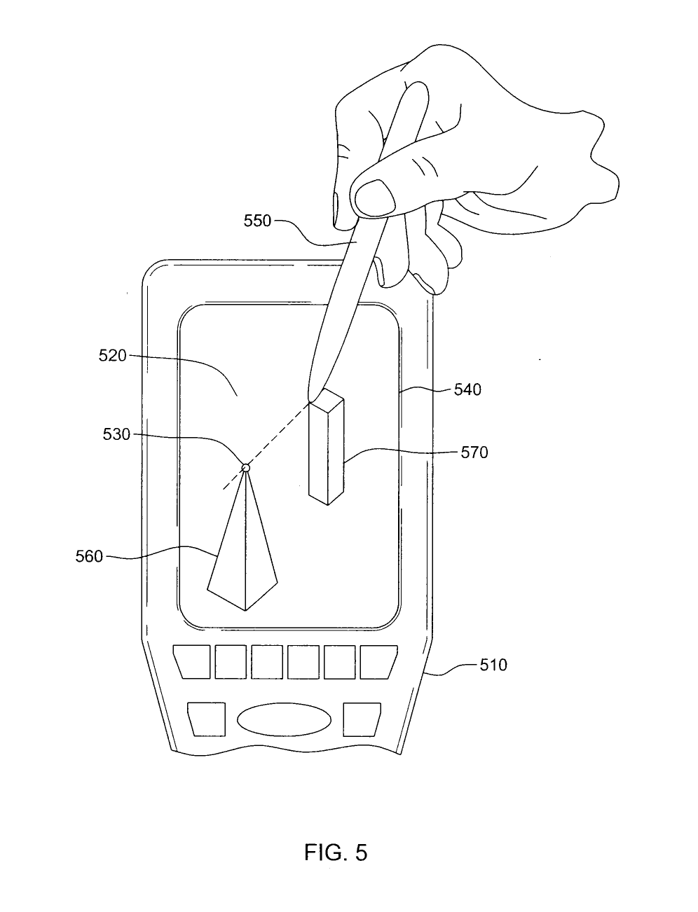

In FIG. 5, the camera (not pictured) and range imaging camera (not pictured) integrated into the device 510, the embodiment pictured, have already captured an image 520 for display in the GUI 530 on the touch screen 540. A user utilizes the inquiry tool 550 to select portions of the displayed image. In this example, the image captured contains two geometric objects, a first object 560 and a second object 570. In the GUI 530, the user selects the first object 560 with the inquiry tool 550 and then selects the second object 570 with the inquiry tool 550. The GUI 530 indicates to the user the distance between the first object 560 and the second object 570 in the real world (as opposed to in the rendering on screen). In this embodiment, because the image 520 in the GUI 530 displays the object using a three dimensional graphical representation, the user can select the plane between the objects 560-570 that he or she wishes to receive the distance measurement on.

Three dimensional spacial measurements taken by the range imaging camera that can be represented in the GUI of an embodiment of the present invention include but are not limited to: (1) the distance between two points in a view; (2) the position and orientation of the camera relative to a coordinated system in the view; (3) the distance to a point on a plane and the angle with the plane; (4) the angle between two lines (or objects) on a view; and (5) the area, volume, and region of a solid.

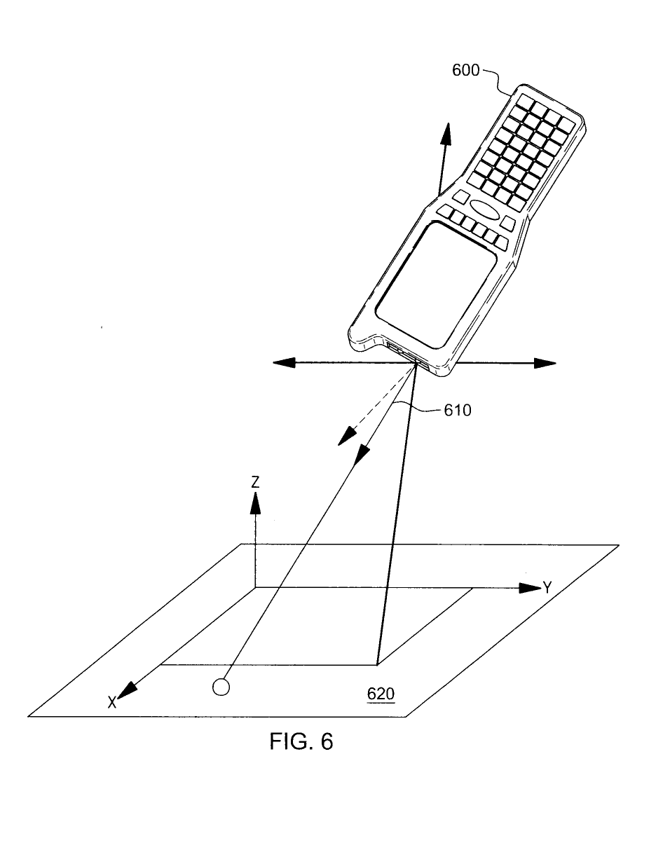

FIGS. 6-9 show an embodiment of the present invention utilizing its range imaging camera to take various measurements that will supply the data that will be displayed to a user in the GUI, who queries information about the image captured and displayed in the GUI.

In taking three dimensional measurements that inform the image rendered in the GUI of an embodiment of the apparatus of the present invention, the orientation, not just the position, of the range imaging camera is important because its measurements are taken from this position. FIG. 6 shows an embodiment of the present invention relative to three coordinate planes, X, Y, Z. The light is emitted from the range imaging camera 610 at an angle and strikes the plane 620. The angle of the light and the distance can be used by the device 600 to derive the position of the range imaging camera 610 relative to the X and Y axes of the plane and the distance from the plane to the range imaging camera, is represented by a position on the Z axis.

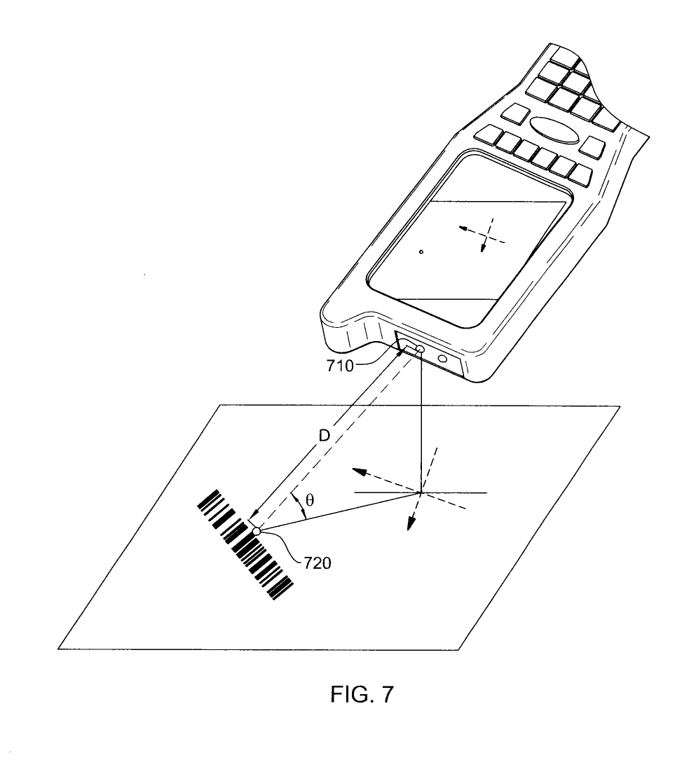

FIG. 7 depicts the determination of the distance and the angle to a point on a plane by the range imaging camera 710 in an embodiment of the present invention. The orientation and position of the range imaging camera 710 are both factors in determining the angle and distance to the point 720.

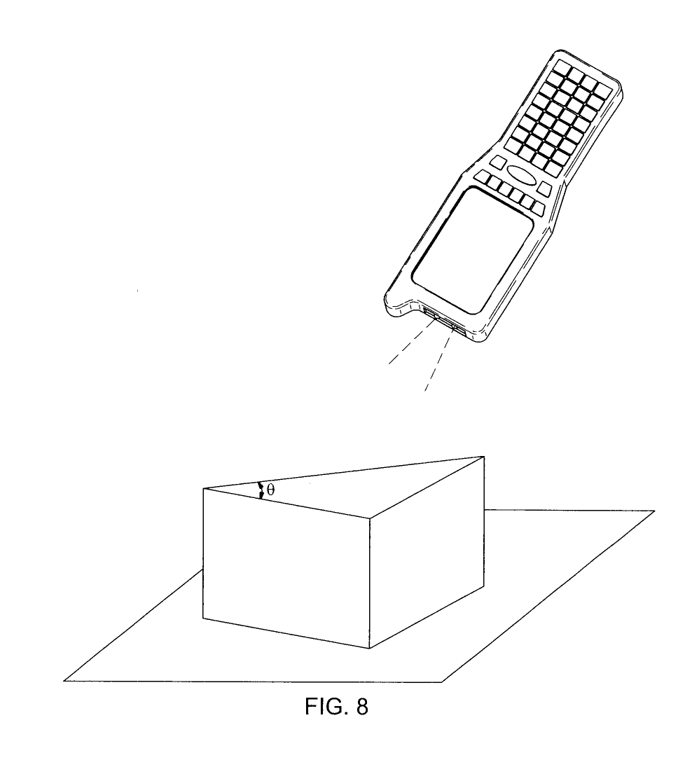

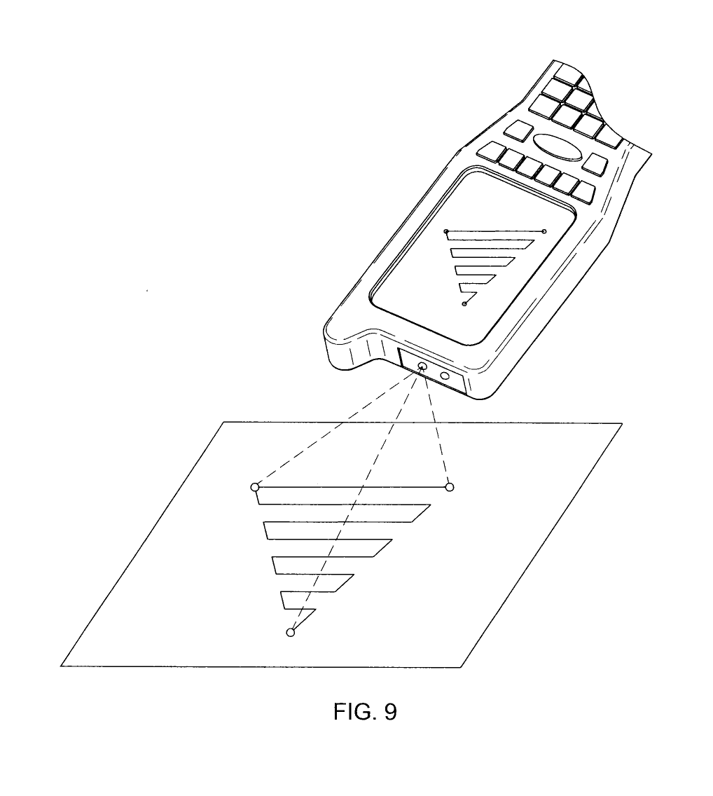

With the embodiment of FIG. 8, an angle between two lines is rendered by utilizing the range imaging camera to measure the depth of various points. FIG. 9 similarly shows how the range imaging camera's measurements are utilized to render the area and volume of a region or solid. In short, by collecting measurements from different points in the field of view, the depth of the objects in the view can be discovered and rendered to users through a GUI.

The GUI of the present invention assists the user in perceiving three dimensionally an image displayed in two dimensions. In an embodiment of the present invention, the image is displayed as both a depth map or a regular image. The two images can be displayed in a variety of ways including, a button may be provided in some embodiments to toggle between these two view, the depth map and the regular image, the screen may be split to show each view, or the touch screen itself could accept inputs allowing a user to toggle in-between views. Some embodiments of the present invention utilize a GUI that offers a rendered 3D view and in response to user inputs, transforms this view, for example, by allowing the user to zoom in and out and shift the center of the image. An embodiment of the present invention allows a user to view a box dimension.

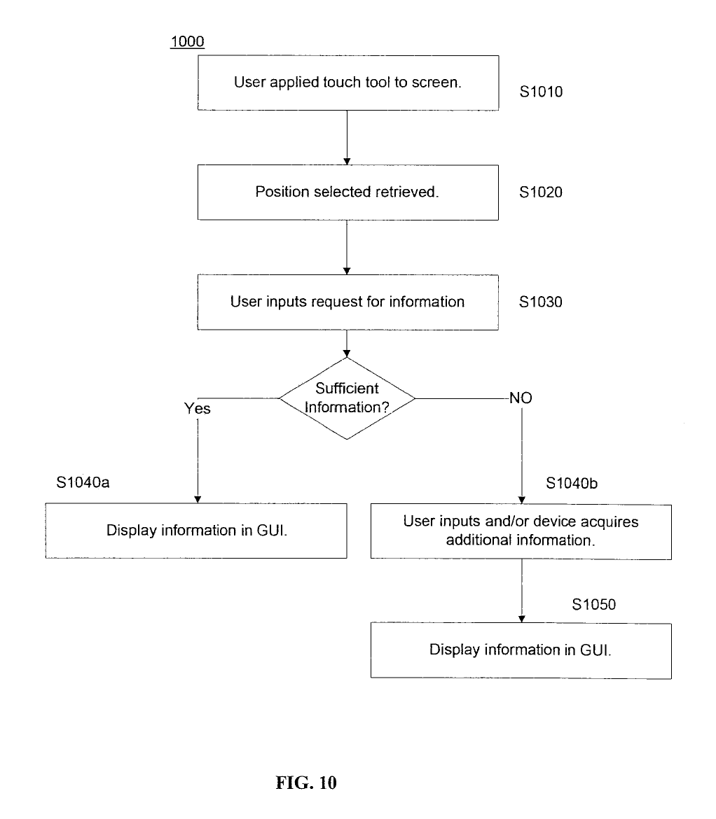

FIG. 10 is a workflow 1000 of the GUI and user interaction through the GUI of an embodiment of the present invention. After the image and depth map have been acquired by the device, the user applies the inquiry tool, shown in this figure as a touch pen, to a portion of the displayed image (S1010). When the touch tool is applied, the position selected will be retrieved, either from a memory resource in the device or externally accessible to the device (S1020). The functionality have the GUI in allowing the user to make a selection is captured in a variety of selection modes, including but not limited to, point, line(s), or plane. Depending upon the selection mode of the device, the device will retrieve different information upon the selection of the user. Coupled with the selection, the user interacts with the GUI to request information (S1030). User requests include but are not limited to the length of a distance between points selected, the angle of the device relative to the point selected on screen, the angle between the two points selected on screen, the area of a point or group of points selected on screen, and/or the volume of a point or group of points selected on screen. The device may retrieve the information selected and display this information or request additional information additional (S1040a-S1040b). If additional information is requested, the user can interface through the GUI to supply this additional information. In response to these additional inputs, the information is retrieved and displayed in the GUI (S1050).

In an embodiment of the present invention, the GUI renders a preview if there are some issues of ambiguity or a further need to fine tune the data or its representation. For example, when a user selected two points on the image displayed in the GUI using the inquiry tool, and requests the distance between the points, one or both points might be in a position near the edge of a plane, and more information may be required to render the result. The user may be prompted to re-orient the device and capture another image and/or depth map. Once the data set is complete enough to answer this query, the results will be displayed in the GUI.

Additional embodiments of the present invention accept different types of user input including, but not limited to, finger touch and/or multiple touch inputs. In an embodiment of the present invention, to avoid the problem of inaccurate position using fingers, the computer program code executed on a processor on a device responds by adding suggested outlines and vertices to guide the user and accept the candidate position nearest to the touched coordinates.

To further avoid user input errors, an embodiment of the present invention allows the user to verify the item selected after the selecting is made. This embodiment displays and/or highlights the selection graphically and awaits user input to recognize or adjust and then conforms to the user selection.

Further embodiments of the present invention accept combined touch events and special graphics input by the user to isolate items in the view and receive 3D information about these items. Inputs include, but are not limited to, drawing a triangle to select the plane, drawing a “<” to select the angle, and/or drawing a line along the outline to select a box or an object.

An embodiment of the present invention may also report the length of curve, area of region, volume of object, reflecting the real world position of objects displayed to the user in the user interface.

Various embodiments of the present invention enable certain functionalities based upon the type of object the user selects through the GUI.

In an embodiment of the present invention, if the user selects a point, additional functionalities are available, including but not limited to: selecting an additional point, getting the coordinated and/or properties of an intersection point (e.g., the intersection of two lines, the intersection of 1 line and 1 plane), getting the properties and/or coordinates of positions on parallel, or non-coplanar lines, getting the properties of the selected point, getting the point coordinates for the selected point, getting the distance to the camera from of the selected point in the global reference frame (not the local reference frame, the GUI).

An embodiment of the present invention contains functionality surrounding the selection of a line on the GUI. By indicating a line, a user can select one or more lines, get an intersection line from plane, get a line with the desired properties (e.g., a line perpendicular to a plane), get the length of (straight) line segment (i.e., the distance between 2 points), get the length of an arc or curve. This list of functions is non-limiting and included as examples.

An embodiment of the present invention offers functionality related to the selection of a plane displayed in the GUI by a user. This functionality relating to a plane includes but is not limited to selecting a plane, selecting a polygon and/or a circle, retrieving values representing the area, perimeter, center of mass, and/or convex hull of a two dimensional polygon, selecting points on lines of the plane, retrieving properties related to the distances between the plane and the camera and/or other objects in the view, such as lines, points, and/or another plane, retrieving the angle of the plane with various objects including with the optic axis, with another plane, and/or with a line, and/or projecting elements onto the selected plane, including points, lines, and/or objects.

An embodiment of the present invention offers functionality related to the selection of an object displayed in the GUI by a user. The functionality related to the object includes but is not limited to selecting the object or solid, selecting a polyhedral or ball, retrieving measurements relating to the selection, including the volume, surface area, the center of mass, and the convex hull, viewing values related to the surfaces of the solid, retrieving the distance from the camera of the object and its parts, retrieving the distance of the object from other items, retrieving the distance and/or angle of the object's location with respect to certain plane, retrieving surface curvature value, retrieving data regarding the type of solid that comprises the object.

An embodiment of the present invention offers functionality related to the selection of a color displayed in the GUI by a user. The functionality related to the color includes but is not limited to retrieving the color value at a selected point, retrieving the mean color of a region, converting the color values between color systems (e.g., RGB, HSV, Lab), filling color into the depth map and augmented image, highlighting a selected region and/or object, making a selected region or object visually transparent, and/or utilizing color to indicate view mode, result type, and process status.

Various embodiments of the present invention allow the user to view the captured image and depth map in a variety of modes. Modes includes but are not limited to 2D view, depth map view, 3D rendering/with texture and/or augmented view. An embodiment of the present invention enables the user to switch between view modes.

An embodiment of the present invention is configured to measure the “box dimension. A further embodiment of the present invention is configured to create models of a scene (a view that the image and depth map are taken of) over the course of time so that a user can view changes in a given object or objects in the scene. In this embodiment, the user selects an object in the view and enters commands to view differences in the position, size, orientation, etc. of this object in different depth maps and images taken over the course of a given time period.

Although the present invention has been described in relation to particular embodiments thereof, many other variations and modifications will become apparent to those skilled in the art. As such, it will be readily evident to one of skill in the art based on the detailed description of the presently preferred embodiment of the system and method explained herein, that different embodiments can be realized.

One or more aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition to the above, one or more aspects of the present invention may be provided, offered, deployed, managed, serviced, etc. by a service provider who offers management of customer environments. For instance, the service provider can create, maintain, support, etc. computer code and/or a computer infrastructure that performs one or more aspects of the present invention for one or more customers. In return, the service provider may receive payment from the customer under a subscription and/or fee agreement, as examples. Additionally or alternatively, the service provider may receive payment from the sale of advertising content to one or more third parties.

In one aspect of the present invention, an application may be deployed for performing one or more aspects of the present invention. As one example, the deploying of an application comprises providing computer infrastructure operable to perform one or more aspects of the present invention.

As a further aspect of the present invention, a computing infrastructure may be deployed comprising integrating computer readable code into a computing system, in which the code in combination with the computing system is capable of performing one or more aspects of the present invention.

As yet a further aspect of the present invention, a process for integrating computing infrastructure comprising integrating computer readable code into a computer system may be provided. The computer system comprises a computer readable medium, in which the computer medium comprises one or more aspects of the present invention. The code in combination with the computer system is capable of performing one or more aspects of the present invention.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

1. A user terminal comprising:
an input/output mechanism;
an image capture device, wherein said image capture device is configured to capture an image of a scene upon receipt of a pre-defined input from said input/output mechanism;
a range imaging image capture device, wherein said image capture device is configured to create a depth map of said scene upon receipt of said pre-defined input from said input/output mechanism;
a processor, wherein said processor is configured, in response to said image capture and said depth map creation, to combine said image and said depth map into a model of said scene;
a memory, wherein said memory is configured to store said depth map and said image; and
a display wherein said display is configured to display said model.

2. The user terminal of claim 1, wherein said model displayed on said display as at least one of: a 2D view, a depth map view, a 3D rendering/with texture, or augmented view.

3. The user terminal of claim 1, wherein said range imaging image capture device is provided by one of: a structured light camera or a time of flight camera.

4. The user terminal of claim 1, wherein said depth map is created utilizing one of: stereo triangulation, sheet of light triangulation, structured light, time-of-flight, interferometry, or coded Aperture.

5. The user terminal of claim 1, wherein said input/output mechanism comprises a touchscreen on said display.

6. The user terminal of claim 1, wherein said a image capture device comprises a digital camera.

7. The user terminal of claim 1, wherein said input/output mechanism is further configured to receive input identifying a first portion of said model;
wherein said processor is further configured, responsive to receiving said input identifying said first portion of said model to retrieve a first plurality of information corresponding to said first portion from said data in said memory; and
wherein said display is further configured to display said first plurality of information.

8. The user terminal of claim 7, wherein said first portion is an object and said first plurality of information contains at least one of: the volume of said object, the surface area of said object, the distance from said object to said image capture device, the distance of said object from a second object, the surface curvature of said object.

9. The user terminal of claim 7, wherein said first portion is a point and said plurality of information contains at least one of: the coordinates of said point, the distance from said point to said image capture device.

10. The user terminal of claim 7, wherein said display is further configured to display a color value corresponding to said first portion.

11. The user terminal of claim 7, wherein said input/output mechanism is further configured to receive a second input identifying a second portion of said model;
wherein said processor is further configured, responsive to receiving said second input identifying said second portion of said model to retrieve a second plurality of information corresponding to said second portion from said data in said memory;
wherein said display is further configured to display said second plurality of information; and
wherein said display is further configured to display a distance between said first portion and said second portion in said scene.

12. The user terminal of claim 11, wherein said input/output mechanism is further configured to display an angle between said first portion and said second portion in said scene.

13. A method for displaying an image by a user terminal comprising a microprocessor, a memory, an image capture device, a range imaging capture device, a display, an input device, said method comprising:
said user terminal capturing an image of a scene;
said user terminal creating a depth map of said scene;
said user terminal retaining said image and said depth map;
said user terminal combining said image and said depth map into a model;
said user terminal displaying said model.

14. The method of claim 13, further comprising:
said user terminal receiving input identifying a first portion of said model;
said user terminal retrieving data relating to said first portion from said depth map;
said user terminal displaying said data.

15. The method of claim 13, wherein said model is at least one of: a 2D view, a depth map view, a 3D rendering/with texture, or augmented view.

16. The method of claim 13, wherein said depth map is creating using one of: stereo triangulation, sheet of light triangulation, structured light, time-of-flight, interferometry, or coded Aperture.

17. The method of claim 14, wherein said first portion is an object and said data contains at least one of: the volume of said object, the surface area of said object, the distance from said object to said image capture device, the distance of said object from a second object, the surface curvature of said object.

18. The method of claim 14 wherein said first portion is a point and said data contains at least one of: the coordinates of said point, or the distance from said point to said image capture device.

19. The method of claim 14, further comprising:
said user terminal displaying a color value corresponding to said first portion.

20. The method of claim 14, further comprising:
said user terminal receiving a second input identifying a second portion of said model;
said user terminal retrieving second data relating to said second portion from said depth map;
said user terminal displaying said second data; and
said user terminal displaying a distance between said first portion and said second portion in said scene.
